(19) United States
(12) Patent Application Publication
(10) Pub. No.: US 2026/0226806 A1
(43) Pub. Date: Aug. 6, 2026

(54) CUTTINGS TREATMENT USING CHEMICALLY ENHANCED CAVITATION

(71) Applicant: SCHLUMBERGER TECHNOLOGY CORPORATION, Sugar Land, TX (US)

(72) Inventors: Reda KAROUM, Houston, TX (US); Steven Philip YOUNG, Houston, TX (US); Albert OKHRIMENKO, Houston, TX (US); Clint FALGOUT, Fulshear, TX (US); Suzett URBANO PENA, Sugarland, TX (US)

(21) Appl. No.: 19/143,445

(22) PCT Filed: May 2, 2024
(86) PCT No.: PCT/US2024/027468

§ 371 Date: Jun. 26, 2025

Related U.S. Application Data
(60) Provisional application No. 63/499,518, filed on May 2, 2023.

(51) Int. Cl. E21B 21/06; B08B 3/08; B08B 7/02

(52) U.S. Cl. CPC E21B 21/066; B08B 3/08; B08B 7/02

(57) ABSTRACT

Methods and apparatus for treatment of solids containing hydrocarbon are described herein. The solids are treated by adding a cavitation cleaner to the stream; introducing the stream, with the cavitation cleaner, to a cavitation unit; and separating oil from the solids using a cavitation process within the cavitation unit.

### CROSS-REFERENCE TO RELATED APPLICATIONS

This patent application claims benefit of U.S. Provisional Patent Application Ser. No. 63/499,518, filed May 2, 2023, which is entirely incorporated herein by reference.

### FIELD

This patent application describes apparatus and methods of treating drill cuttings in hydrocarbon prospecting. Specifically, the apparatus and methods described herein use chemically enhanced cavitation processes to provide effective and environmentally conservative hydrocarbon removal from drill cuttings.

### BACKGROUND

Hydrocarbon is commonly sought by drilling a hole in the earth to establish a conduit from a subterranean hydrocarbon reservoir to the earth's surface. As the hole is drilled, fragments of rock, sand, water, and other materials are brought to the surface. When hydrocarbon is flowed to the surface using the well, the hydrocarbon often brings other materials, such as water, sand, pebbles, rock fragments, dust, and the like that are separated from the hydrocarbon at the surface. The solids are commonly referred to as “cuttings.” It is typically desired to return the cuttings to the environment without damaging the environment, but to do so hydrocarbon, potentially from the reservoir and/or from drilling fluids, must be removed from the cuttings. The cuttings are usually at least coated with hydrocarbon, which can be hydrocarbon from the reservoir, hydrocarbon from drilling fluids (i.e. oil base mud or synthetic base mud), or both, and may be penetrated to some extent by hydrocarbon, so a hydrocarbon removal process is used to remove the hydrocarbon. Conventional treatment processes are energy intensive, expensive, environmentally burdensome, and only marginally effective, so improved processes for removing hydrocarbon from produced cuttings are needed.

### SUMMARY

Embodiments described herein provide a method of treating solids containing hydrocarbon, the method comprising adding a cavitation cleaner to the stream; introducing the stream, with the cavitation cleaner, to a cavitation unit; and separating oil from the solids using a cavitation process within the cavitation unit.

### BRIEF DESCRIPTION OF THE DRAWINGS

FIG. 1 is a schematic process diagram of a solids treatment process according to one embodiment.

### DETAILED DESCRIPTION

Efficient, environmentally conservative, and effective treatment of solids like drill cuttings produced with hydrocarbon uses a cavitation unit, along with chemical reagents to enhance the effect of the cavitation unit. The solids are mixed with chemical agents, such as surfactants, and provided to the cavitation unit, which creates shock waves in a fluid by rapidly collapsing bubbles in the fluid. The chemical agents are selected to ensure the solids are substantially water wet within the fluid prior to entry into the cavitation unit.

Cavitation is a phenomenon marked by momentary creation of vapor domains in a liquid medium. The vapor domains, after being created, collapse in a fraction of a second and the collision of the fluid walls of the vapor domain in the collapse creates acoustic shock waves that propagate through the liquid medium. Generally, the mechanical energy density of the acoustic stock waves can be higher than the energy input to create the vapor domains, so cavitation can be understood as a resonance phenomenon that has a gain in mechanical energy by use of a driving energy selected to produce the gain of mechanical energy in the system. This phenomenon can be used to create very energetic treatment of solid particles in a fluid medium to dislodge adhered or adsorbed materials from the solid particles.

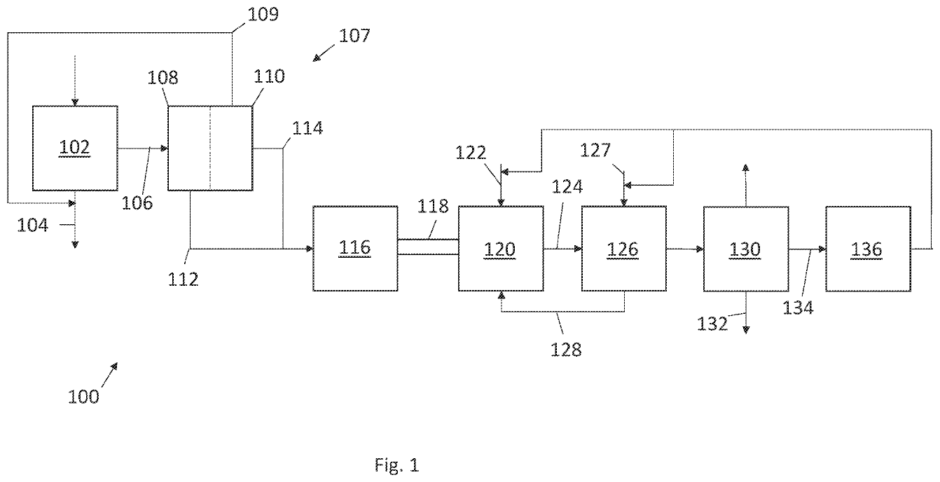

FIG. 1 is a process diagram summarizing a process 100 of treating according to one embodiment. The process 100 can be used to practice a method of treating solids containing hydrocarbons. The solids can be solids emerging from a well during drilling. In such cases, drilling fluid, which typically contains hydrocarbon, flows out of the well to the surface carrying fluidized solids from the drilling process. The solids are typically provided to a bulk separator 102, which can be a shaker or screen separator, to separate bulk liquid from the solids. The separated liquid 104 can be routed to other uses, such as formulation of drilling fluids for use in the well.

Separated solids 106 are routed to an initial cleaning stage 107, where the solids are dried in a dryer 108 and fines are separated from liquid in a density separator 110 such as a centrifuge. Fluid removed in the dryer 108 are routed to the density separator 110. Dried solids 112 are recovered using the dryer 108. The dried solids 112 typically contain organic species such as hydrocarbon and surfactants that were not removed by the drying process. Fines 114 recovered in the density separator 110 can be combined with the dried solids 112 or routed to other uses. Fluids 109 separated in the density separator 110 can be combined with fluids separated in the bulk separator 102, or routed separately to other uses, such as formulation of drilling fluids.

The dried solids 112, optionally including the fines 114, are subjected to a sizing process to ensure effective treatment in the cavitation unit, described below. The solids are routed to a sizing unit 116, which may be a grinder, mill, tumbler or other physical processor that breaks down solids into smaller particles, typically 3 cm or less in size, but larger particles can be accommodated.

The sized particles are routed to a tank 120, where a composition containing the sized solids is prepared for a cleaning treatment. Water is added to the sized solids, which may be sea water, produced water, process water, or other suitable water to provide a medium for introducing chemical cleaning agents. The sized solids may be transported to the tank 120 using a solids conveyor 118, which may be a screw conveyor or other suitable device. Water and chemical cleaners 122 are added in the tank 120, in the conveyor 118, or both. For example, a screw conveyor may be equipped with a spray assembly to spray fluid into the interior of the screw conveyor as solids are transported therein.

The cleaning agents are surfactants that are selected to render the solids water wet. The surfactants may be oil soluble surfactants, water soluble surfactants, or pH dependent surfactants, whose surfactant function depends on pH of the water phase. Examples of oil soluble surfactants that can be used include Deep Clean NS, Safe Surf W, Safe Surf EU, EMR961, B636, B197 and B482, all available from Schlumberger, Ltd., of Houston, Texas. Examples of water-soluble surfactants that can be used include bio-surfactants such as Rewoferm SL466 and Aerosurf SF 1975, both available from Evonik, and glycols such as polyethylene glycol. An example of a pH dependent surfactant is ECF-1867 CW available from Nouryon. Another example of surfactants are ethoxylated alcohols. A foaming agent can also be added. An activating agent can also be added to activate the surfactant. For example, a pH adjustment agent can be added if the surfactant is pH dependent. In the case of ECF-1867, lowering pH causes the surfactant to activate, rendering solids immersed in the fluid water wet. Citric acid, carbonic acid, or another mild acid can accomplish the activation by lowering pH of the fluid below 7, for example 5 to 6. Mineral acids such as HCI and H₂SO₄ can also be used in amounts to bring the pH of the fluid below 7, and if desired the amount of such acids used can be limited to keep pH of the fluid above 5 to minimize an chemical effects on equipment. Where an organic acid is used, amount of the acid can also be limited to minimize organic species that might dissolve in water, and that might need to be removed before water can be returned to the environment.

It should be noted that pH-dependent agents such as ECF-1867 can be used in drilling fluids as emulsifiers. In such cases, the ECF-1867 remaining in the oil on the solids after the initial separation in the bulk separator 102 can be useful as the pH dependent surfactant. In such cases, the initial cleaning stage 107 can be bypassed, and the solids, with significant oil inclusion, can be routed directly to the sizing unit 116. Any needed additional surfactant such as ECF-1867 can be added, along with acid activator. Following cavitation treatment, where an oil phase is recovered in the separator 130, the oil phase can have enough ECF-1867 remaining to be attractive to recover for drilling fluid blending. In such cases, a basic material can be added to the oil phase recovered at the separator 130 to convert the ECF-1867 back into emulsifier, and the oil phase can then be routed to drilling fluid blending.

From the tank 120, the solids, and the fluid medium in which the solids are disposed, are transported in a slurry 124 to a cavitation unit 126. The cavitation unit 126 comprises a tank with one or more orifices or nozzles configured to flow fluid at high velocity. The high velocity fluid flow generates a low-pressure zone that gives rise to bubbles that subsequently collapse rapidly. The collapsing bubbles generate shock waves, micro-jets, and extreme local thermodynamic conditions that, near solids bearing hydrocarbon can dislodge and momentarily vaporize the hydrocarbons. Some hydrocarbons distribute between vapor and liquid phases in bubbles and the surrounding liquid. The fluid pumped through the orifices and/or nozzles may be the liquid of the slurry provided to the cavitation unit or another liquid stream. The fluid is usually water or mostly water. Here, a sea water stream 127 is provided as a cavitation inducing fluid. Additionally, or alternately, a sea water stream such as the sea water stream 127 can be provided to the tank 120, either with the chemical cleaners 122 or separately. A cavitation unit that can be used to practice the methods herein is available from Envorem Ltd. of London, UK.

The contents of the cavitation unit 126 can, in part, be circulated back to the tank 120 to provide a residence time of bubbles and solids to loosen any firmly adhered hydrocarbon on the solids. A recycle line 128 flows some of the slurry in the cavitation unit 126 back to the tank 120, where the recycled solids are eventually returned to the cavitation unit 126. The recycle line 128 is generally coupled to the cavitation unit 126 at a lower region thereof to minimize recycle of released hydrocarbon. Volume and/or flow rate of the recycled slurry can be controlled to provide a desired mixing intensity in the tank 120. Volume and/or flow rate of the recycle slurry can also, or alternately, be controlled to provide a desired residence time of solids with chemical cleaning agents so that the chemical cleaning agents have time to reach oil-wet surfaces of the solids and to penetrate pore structures of the solids. In some cases, the cavitation can be induced in the recycle line.

Surfactants and other additives added prior to routing the slurry to the cavitation unit 126 have at least two functions. First, the surfactants directly separate at least some organic material from solids in the slurry into the liquid phase. Second, the additives also generally maintain direct contact between the liquid and solid phases of the slurry to optimize delivery of mechanical energy from the liquid to the solid phase. The liquid phase can even penetrate into pores of the solids. Because the liquid phase transmits the mechanical energy created by collapsing bubbles in the cavitation unit 126, high energy pressure waves impinge directly on the solids, dis-adhering hydrocarbon in the vicinity of the wave point of contact with the solid surface, which can be within a pore where hydrocarbon might be deeply adhered within the solid particle. The surface energy effect of the surfactants maintains contact between the liquid phase and the solid surface as hydrocarbon is released and as strong pressure waves impact the solid surface. Repeated bombardment of the solid particles with high energy pressure waves from the induced cavitation, chemically enhanced by the action of the surfactants, generally reduce OOC of the solids to less than 1%. Foaming agents can enhance the effect of the cavitation unit by enhancing the creation of bubbles in the fluid.

Materials treated in the cavitation unit 126 are routed to a separator 130, where solids, liquids, and gases are separated by gravity. Clean solids and some water are discharged from a lower region of the separator 130, where the solids have OOC less than 1%. The solids can be discharged using a screw conveyor to minimize water discharged with the solids, so that a wet solids stream 132 can be returned to the environment. A generally aqueous phase collects in middle areas of the separator 130. The aqueous phase can contain fines solids and trace oil and chemicals. A water stream 134 can be withdrawn from the separator 130 and routed to a conventional water treatment system 136. Clean water recovered in the water treatment can optionally be reused in the tank 120 or the cavitation unit 126. An oil phase, which is hydrocarbon separated from the solids, potentially also containing some chemicals is recovered at an upper region of the separator 130, and can be routed to suitable uses or disposal.

The separator 130 can be energetically enhanced. For example, the separator 130 can be an electrical separator that applies a static or time-varying electric field to fluid within the separator to enhance gravitational separation. The separator 130 can also energize the fluid therein using acoustic waves tuned to a frequency that enhances gravitational separation of fluids in the separator.

The cavitation unit can be a pump, an orifice, a cavitation inducing flow path such as a Venturi path, an acoustic or ultrasonic cavitator, a thermal cavitator, an electrostatic cavitator, an electromagnetic cavitator (e.g. microwave, infrared, and or visible light), or any combination thereof. For example, a cavitation pump can be used with piezoelectric acoustics or ultrasonics to provide cavitation performance that can be controlled, for example allowing cavitation to be increased or decreased as needed. Acoustic generators can be used with other cavitation devices to enhance cavitation or merely to add acoustic pressure waves to a fluid medium along with cavitation pressure waves. Likewise thermal, electrostatic, and electromagnetic devices can be included, along with acoustic and hydrodynamic devices, to provide a broad array of types of pressure wave energy in a fluid medium. Thus, a cavitation unit can include any device selected from the group consisting of a hydrodynamic device, an acoustic device, a thermal device, an electrostatic device, an electromagnetic device, or a combination thereof.

Cavitation is generally induced when a liquid momentarily experiences pressure near or below a vapor pressure of the liquid so that vapor phases form within the liquid and then rapidly collapse. Cavitation can be induced by momentarily reducing pressure within the liquid, momentarily raising vapor pressure of the liquid, or a combination thereof. Thus, the cavitation unit 126 may be, or may include, a cavitation pump that induces a suction pressure in the slurry that is near or below the vapor pressure of the liquid phase to create vapor domains within the liquid. The pump the raises the pressure of the slurry upon discharge to collapse the vapor domains. A pressure drop device, such as a flow restriction, can be used in the suction of a pump, a cavitation pump or other pump, to induce cavitation. A thermal, electrical, or electromagnetic device can be used, alone or with a flow restriction, optionally with a pump, to induce cavitation. The thermal, electrical, or electromagnetic device can add energy to the liquid medium of the slurry to increase its temperature, at least locally, to raise the local vapor pressure of the liquid such that vapor domains form. For example, an orifice incorporating a heated mesh can be disposed in a flow passage, such as a pipe, to simultaneously drop the pressure of the liquid phase and raise its temperature near the wires of the heated mesh.

Such cavitation components can be adjusted to control a degree or intensity of the cavitation in the system. For example, an adjustable flow device can be used to adjust pressure drop to increase or decrease cavitation. An adjustable electomagnetic or thermal energy device can be similarly adjusted to adjust the vapor pressure of the liquid medium. Where more cavitation might improve cleaning of solids, cavitation can be increased by adding thermal or electromagnetic energy, and/or pressure drop increased, to increase degree and/or intensity of cavitation, and vice versa.

Mixing different intensity pressure waves from cavitation and other fluid pressure wave phenomena can be useful where solid materials to be cleaned using fluid pressure waves include solids having low hardness or low strength. Solid particles having low hardness or strength can be fractured by the force of high intensity pressure waves of the sort generated by fully developed cavitation. Where such solids might have adhered or adsorbed oily material, the result can be an oily paste that can be difficult to separate. Where the solids being processed include such materials, clay as an example, intensity of the pressure waves can be tuned or selected to approach a threshold at which the solids might start to fracture. For example, if solids are known to have compressive strength C, pressure waves having maximum pressure amplitude of 0.9 C can be formed in the liquid medium to avoid substantially fragmenting the solids.

The cavitation unit 126 can be operated in any convenient and suitable way to provide optimal solids cleaning. In one type of embodiment, cavitation may be cycled. For example, in one embodiment a cavitation source in the cavitation unit 126 may be pulsed, that is, cycled on and off repeatedly at a frequency selected to improve cleaning of solids in the cavitation unit. Pulsed cavitation will periodically introduce cavitation energy within the cavitation unit to encourage separation of organic material from solids. Pulsed cavitation can be useful where the solids includes solids prone to fracture under the stress of continuous cavitation processing. In such cases, cavitation can be pulsed to avoid building stresses within such solids to a fracture point. Pulsed cavitation can also improve removal of organics in some cases by allowing some relaxation or reflow of adsorbed or absorbed organics between cavitation pulses. Such methods can allow the fluid-solid association to change between pulses to a configuration more susceptible to removal by cavitation pressure waves such that a subsequent pulse of cavitation pressure waves dislodges incrementally more organic material from the solids.

In other embodiments, intensity of cavitation can be modulated between a high value and a low value at a selected frequency, which can also be changed according to any suitable pattern. Such intensity cycling in a cavitation process can also reduce the prevalence of solids fracture and/or optimize separation of organic material from solids. Where a cavitation source is paired with an acoustic source, operation of the cavitation unit can be cycled between sonication and cavitation. In some cases, for example cases where solids are particularly sensitive to fracture, sonication may provide some level of separation between organics and solids in the mixture, and cavitation can be used sparingly to loosen tightly adhered organics or dislodge deeply adhered organics. It should be noted that where cavitation is provided or enhanced using an adjustable source, such as a thermal, acoustic, electrostatic, or electromagnetic source, cavitation intensity or duty cycle can be adjusted or modulated by adjusting such sources. For example, a thermal or electrical (electrostatic and/or electromagnetic) cavitation source can be deactivated to stop cavitation or adjusted to change cavitation output.

Sensitivity of solids to cavitation processing can be used to control operation of the cavitation unit 126. For example, where a solids containing stream is flowing from a subterranean source, characteristics of the solids that might make them sensitive to fracture during cavitation processing can be anticipated, and operation of the cavitation unit 126 adjusted accordingly. For example, solids can be sampled at an upstream location, for example at the bulk separator 102 or the dryer 108, and analyzed for sensitivity to fracture. For example, a specially-configured grinding process can be performed on the solids, and particle size distribution analyzed before and after grinding, to determine a sensitivity to cavitation. Additionally or alternately, the type of solids can be ascertained and related to fracture sensitivity. For example, the solids can be analyzed for clay content, and cavitation intensity adjusted accordingly. Additionally or alternately, pre-existing information regarding the subterranean environment, such as well logs, can be used to predict characteristics of the solids being provided to the bulk separator 102 and/or the dryer 108, and operation of the cavitation unit 126 adjusted accordingly. Collection of energy signature data, such as gamma ray data, sonic data, or combination thereof, while drilling a well can be used to ascertain types of solids at different depths within the well. Such data can be used to predict the solids being surfaced as material is withdrawn from the well, and operation of the cavitation unit 126 can be adjusted based on characteristics of the solids that may be known based on the type of solids being surfaced.

In one embodiment, solids can be separated based on one or more characteristics prior to cavitation processing. As solids are surfaced from the well, characteristics of the solids can be analyzed or predicted, as described above, and solid can be separated into two or more containers, such as tanks, for cavitation processing according to the characteristics. For example, where harder and softer materials are surfaced from a well, for example where clay, sandstone, siltstone, and carbonate solids are surfaced, solids can be separated by hardness into two or more containers. For example, clays, which can be more susceptible to fracture during cavitation processing, can be separated from harder solids such as sandstone, siltstone, and carbonate solids. The harder and softer materials can then be subjected to cavitation processing in batches.

Thus, for example, solid materials exiting the bulk separator 102 can be separated into two or more containers. When a first container reaches a suitable inventory of solids, the solids in that container can be routed to the dryer 108, separator 110, sizing unit 116, tank 120, and on to cavitation process in the cavitation unit 126. The operation of all the units in the process 100 can be adjusted according to characteristics of the solids being processed. Where the solids have high hardness, for example Shore hardness above a threshold, processing in the cavitation unit 126 can be configured to a high intensity. Where the solids have low hardness, for example Shore hardness below a threshold, processing in the cavitation unit 126 can be configured to a low intensity. These thresholds can be the same or different. For example, high intensity processing can be practiced when Shore hardness of the solids is above a first threshold and low intensity processing can be practiced when Shore hardness of the solids is below a second threshold, where the second threshold is lower than the first threshold. When inventory in the first container reaches an endpoint, flow from the first container can be discontinued and flow from a second container, containing solids having different characteristics, can be started to the dryer 108. The units of the process 100 can be reconfigured according to the different characteristics of the solids in the second container. If suitable and convenient, the units of the process 100 can be reconfigured after flow from the first container is discontinued and before flow from the second container is started. Thus, the process 100 can be afforded an adjustment period between processing periods, if such adjustment period is advantageous.

The interior of the cavitation unit 126 can be subjected to mixing before, during, and/or after cavitation processing to affect characteristics of the cavitation unit 126 effluent. For example, an agitator of any suitable kind can be disposed in the interior of the cavitation unit 126 to agitate the fluid mixture within. Where a cavitation source of the cavitation unit 126 emits cavitation pressure waves from a particular location, the pressure waves attenuate while propagating away from the source. In such cases, location history of solids within the cavitation unit 126 can affect the results of cleaning those solids. For example, where solids spend a lot of time relatively close to the cavitation source, those solids might be subject to a higher risk of fracture, and where solids spend a lot of time far from the cavitation source, those solids might emerge from the cavitation unit 126 having more organic content than desired. Mixing the interior of the cavitation unit 126 can homogenize exposure of solids within to cavitation pressure waves, and can improve the result of cavitation processing in some cases.

A sensor unit 138, which may be a single sensor or a sensor station comprising a plurality of sensors, can be coupled to an effluent of the cavitation unit 126 to sense one or more characteristics of the effluent. The sensor unit 138 produces one or more signals representing the one or more characteristics, which can be used to control operation of the cavitation unit 126. The sensor unit 138 may sense composition or quality of the effluent, either of the liquid phase, the solid phase, or both, to generate the signals. The characteristic can be actual composition of the effluent or a characteristic, such as an optical, electrical, or other characteristic that indicates composition of the effluent. For example, characteristics such as electrical conductivity can indicate a quantity of organic material removed from the solid phase into the liquid phase. Solids may be directly sampled and analyzed for oil content. Any suitable analysis can be included in the sensor unit 138.

Signals from the sensor unit 138 can be used to control recycle of effluent from the cavitation unit 126 to the tank 120. Where, for example, signals from the sensor unit 138 indicate solids are not being cleaned sufficiently, recycle of the cavitation unit effluent can be increased to intensify processing. Likewise, cavitation intensity can be adjusted, and use of additives can also be adjusted based on the signals from the sensor unit 138.

An acoustic sensor 140 can be coupled to the cavitation unit 126 to obtain an acoustic signal from an interior of the cavitation unit 126. The acoustic signal can be used to sense one or more characteristics of the cavitation operation of the cavitation unit 126. For example, cavitation intensity in the cavitation unit 126 can be inferred from intensity of an acoustic signal obtained from the interior of the cavitation unit 126. The acoustic sensor 140 may be, or may include, a microphone disposed in the interior of the cavitation unit 126, or along an exterior surface of the cavitation unit 126, in the interior of an inlet or effluent line of the cavitation unit 126, or along an exterior surface of an inlet or effluent line of the cavitation unit. More than one acoustic sensor 140 can be used where suitable, for example if different characteristics of the operation of the cavitation unit 126 can be inferred from acoustic signals obtained at different locations.

While the foregoing is directed to embodiments of the present invention, other and further embodiments of the present disclosure may be devised without departing from the basic scope thereof, and the scope thereof is determined by the claims that follow.

1. A method of treating solids containing hydrocarbon, the method comprising:
adding a cavitation cleaner comprising an oil-soluble surfactant, a water-soluble surfactant, a pH dependent surfactant, or any combination thereof, to a stream containing the solids to be treated;
introducing the stream, with the cavitation cleaner, to a cavitation unit; and
separating oil from the solids using a cavitation process within the cavitation unit.

2. A method of treating solids containing hydrocarbon, the method comprising:
adding a cavitation cleaner comprising an oil-soluble surfactant, a water-soluble surfactant, a pH dependent surfactant, or any combination thereof, to a stream containing the solids to be treated;
introducing the stream, with the cavitation cleaner, to a cavitation unit;
separating oil from the solids using a cavitation process within the cavitation unit to form a solids-containing effluent and a liquid effluent;
analyzing a characteristic of the solids-containing effluent, the liquid effluent, or both; and
adjusting operation of the cavitation unit, addition of the cavitation cleaner, or both, based on the analysis.

3. A method of treating solids containing hydrocarbon, the method comprising:
adding a cavitation cleaner comprising an oil-soluble surfactant, a water-soluble surfactant, a pH dependent surfactant, or any combination thereof, to a stream containing the solids to be treated;
obtaining a characteristics of the solids to be treated;
introducing the stream, with the cavitation cleaner, to a cavitation unit;
separating oil from the solids using a cavitation process within the cavitation unit to form a solids-containing effluent and a liquid effluent;
adjusting operation of the cavitation unit based on the characteristic of the solids to be treated;
analyzing a characteristic of the solids-containing effluent, the liquid effluent, or both; and
adjusting operation of the cavitation unit, addition of the cavitation cleaner, or both, based on the analysis.

4. The method of claim 1, wherein the cavitation cleaner comprises a water-soluble bio-surfactant.

5. The method of claim 4, wherein the cavitation unit includes a cavitation source selected from the group consisting of a hydrodynamic device, an acoustic device, a thermal device, an electrostatic device, an electromagnetic device, or a combination thereof.

6. The method of claim 5, wherein the cavitation process includes mixing the stream at the cavitation unit.

7. The method of claim 6, further comprising, prior to introducing the stream to the cavitation unit, sizing the solids.

8. The method of claim 7, wherein the cavitation process comprises inducing cavitation in a liquid phase of the stream, and the method further comprises controlling an intensity of the cavitation.

9. The method of claim 2, wherein adjusting operation of the cavitation unit comprises recycling a portion of the solids-containing effluent to the stream introduced to the cavitation unit.

10. The method of claim 1, further comprising obtaining an acoustic signal from an interior of the cavitation unit and adjusting operation of the cavitation unit based on the acoustic signal.

11. The method of claim 10, wherein adjusting operation of the cavitation unit comprises adjusting an intensity of cavitation in the cavitation unit.

12. The method of claim 11, wherein the cavitation process comprises cycling a cavitation source of the cavitation unit.

13. The method of claim 2, wherein the cavitation process comprises cycling a cavitation source of the cavitation unit and adjusting operation of the cavitation unit comprises adjusting a characteristic of the cycling.

14. The method of claim 13, wherein the cavitation process comprises cycling a cavitation source within the cavitation unit.

15. The method of claim 3, further comprising, prior to separating oil from the solids using a cavitation process within the cavitation unit to form a solids-containing effluent and a liquid effluent, separating the solids according to the characteristic of the solids.
